(19) United States
(12) Patent Application Publication
(10) Pub. No.: US 2006/0155405 A1
(43) Pub. Date: Jul. 13, 2006

(54) Method of creating a dual curve support structure

(76) Inventor: L. William Zahner III, Kansas City, MO (US)

Correspondence Address: HOVEY WILLIAMS LLP, 2405 GRAND BLVD., SUITE 400, KANSAS CITY, MO, 64108, US

(21) Appl. No.: 11/032,959

(22) Filed: Jan. 11, 2005

(51) Int. Cl. G06F 19/00

(52) U.S. Cl. 700/98

(57) ABSTRACT

A program for defining a support structure for a dual curved surface preferably runs on computer equipment (10) and receives a definition of the surface. The program then extracts a first curve and a second curve from the definition. The program defines at least two headers (14) matching the first curve and a plurality of ribs (16) matching the second curve. The program defines the spacing for the headers (14) and ribs (16), such that the surface is adequately supported, defines the attachment points for the ribs (16) along the headers (14), and rib angles for the attachment points. The program then generates control files for use by a machine (24) in producing the headers (14) and ribs (16).

### BACKGROUND OF THE INVENTION

1. Field of the Invention

The present invention relates to architectural and building design systems. More particularly, the present invention relates to a computer program and method that may be used to create a support structure for a surface having a dual curve.

2. Description of Prior Art

Builders and architects are increasingly using metal sheets to clad buildings. These sheets are typically manipulated to provide an aesthetic facade. For example, metal sheets may be curved to present a more gentle corner or provide three dimensional depth to a surface of a building.

However, current manufacturing and design constraints only allow builders to bend or curve metal sheets along one axis. Furthermore, current support structures for these sheets only provide support along a single curvature.

Accordingly, there is a need for an improved computer program and method that may be used to create a support structure for a surface having a dual curve.

### SUMMARY OF THE INVENTION

The present invention overcomes the above-identified problems and provides a distinct advance in the art of architectural and building design systems. More particularly, the present invention provides a computer program and method that may be used to create a support structure for a surface having a dual curve. The program is preferably run on computer equipment that is capable of not only defining the support structure but also running other computer aided design or drafting (CAD) software, such as AutoCad from Autodesk, Inc.

The computer equipment preferably receives a definition of the surface in the form of a definition file that defines the surface in terms of a first curve and a second curve. The surface is preferably intended to form at least a portion of a building's exterior. Therefore, the definition file may be extracted from a design for the building or created separately therefrom.

Where the surface is rectangular, the curves are preferably oriented at approximately ninety degrees with respect to each other. For example, the first curve is preferably taken along a horizontal axis of the surface, while the second curve is preferable taken along a vertical axis of the surface. However, the surface may be virtually any shape and the curves may be oriented at other angles with respect to each other. For example, if the surface is shaped like a parallelogram, then the first curve is preferably taken along one side and the second curve is taken along an adjacent side. In this case, an angle between the curves would substantially match an angle between the sides of the parallelogram. In any case, it should be noted that the curves may or may not be constant. For example, either one or both of the curves may be a simple curve or a compound curve. Furthermore, both curves may be substantially identical, such that the surface forms a portion of a sphere.

Once the curves have been extracted from the definition file, the program defines two or more headers and a plurality of ribs that will be combined to form the support structure. The headers and ribs each have a forward edge which preferably contacts the surface, a rear edge opposed to the forward edge, and two opposing end edges. The headers are preferably defined such that their forward edges match the first curve and preferably aligned parallel to one another. More specifically, the headers are preferably horizontally aligned one directly above another. However, the headers may be aligned at an angle and/or offset from one another, depending upon the shape of the surface.

The ribs are preferably defined such that their forward edges match the second curve. The ribs are preferably placed normal to and connecting the headers. The ribs preferably extend vertically between the headers and are preferably aligned parallel to one another. However, the ribs may be aligned at an angle and/or offset from one another, depending upon the shape of the surface. Furthermore, each rib, or selected ones of the ribs, may be placed at different angles with respect to neighboring ribs.

The headers and ribs are preferably cut or punched from sheet metal by a metal working machine and are intended to support a metal skin which contacts at least some portion of the forward edges, conforms to the curves, and forms the surface, as defined in the definition file. Since the skin is preferably intended to form at least a portion of the building's exterior, the skin must be adequately supported. Therefore, spacing of the headers and ribs can be critical. Factors, such as thickness, length, and strength of the metal from which the headers and ribs are constructed, must be considered by the program, in determining a spacing for the headers and ribs. Considering these and any other applicable factors, the program defines the spacing.

One or more rib angles must also be determined by the program, in order to accommodate the curvature of the surface. The program preferably defines each rib angle to ensure that each rib's forward edge is properly aligned with respect to the headers. Each rib is also preferably normal to the skin, in order to allow the full thickness of the headers and ribs to be used to support the skin. It should be noted that the ribs may be aligned substantially normal to the headers or may be angled with respect to three axis. For example, the program may use a constant rib angle, such that each rib would be aligned approximately normal to the headers and substantially parallel to each other. Alternatively, the program may define individual rib angles for each rib.

The headers are preferably connected to the ribs using a slot and tab attachment system. For example, the headers preferably define a plurality of slots. Each rib preferably includes at least one tab that extends from each end edge and fits snugly within an appropriate slot in the headers. Thus, the slots and tabs are combined to form attachment points connecting the headers and ribs together. While the tabs simply extend from the end edges of the ribs, the slots must be spaced according to the spacing and aligned at the appropriate rib angle. Thus, in defining the headers, the program preferably also defines how many slots are needed, as well as each slot's location and orientation.

In the preferred embodiment, defining the headers and the ribs essentially entails generating a unique pattern for each header and each rib. The patterns may be displayed within the computer equipment, in order to allow the user to visually confirm each header and each rib. The patterns may also be printed out on a printer or plotter, thereby allowing the user to manipulate the patterns, as well as transfer the patterns to any material he or she chooses. While the patterns are preferably scaled to the exact size of the headers and ribs, the patterns may be scaled up or down according the user's wishes. This feature is especially helpful in creating a model or for use in other demonstrative functions.

The program then generates at least one control file from the patterns which contains machine control code that may be used by the machine to produce the headers and ribs. Alternatively, the control file may be generated directly without creating the patterns. In either case, the program generates and makes the control file available to the machine.

In use, the computer equipment receives the definition of the surface, preferably in the form of the definition file. The program then extracts the first curve and the second curve from the definition file. The program defines the headers with the forward edge thereof substantially matching the first curve. The program defines the ribs with the forward edge thereof substantially matching the second curve. The program defines the spacing for the headers and ribs, such that the surface is adequately supported. The program defines the attachment points for the ribs along the headers. The program defines the rib angles for the attachment points, such that the forward edge of the ribs may be secured flush with and substantially normal to the surface. The program then defines the patterns for the headers and ribs. Finally, the program generates the control files for use by the machine in producing the headers and ribs.

### BRIEF DESCRIPTION OF THE DRAWINGS

A preferred embodiment of the present invention is described in detail below with reference to the attached drawing figures, wherein:

FIG. 1 is a schematic diagram of computer and other equipment that may be used to implement a preferred embodiment of the present invention;

FIG. 2 is a perspective view of a support structure created in accordance with the present invention and designed to support a surface having a dual curve;

FIG. 3 is a plan view of one of a plurality of headers of the support structure;

FIG. 4 is a plan view of one of a plurality of ribs of the support structure;

FIG. 5 is a block diagram of major processes of the present invention;

FIG. 6 is a block diagram of an input process of the present invention;

FIG. 7 is a block diagram of an analysis process of the present invention;

FIG. 8 is a block diagram of a definition process of the present invention;

FIG. 9 is a block diagram of an output process of the present invention; and

FIG. 10 is flow chart showing the steps to generate control files from which a machine may create the headers and ribs of the support structure in accordance with a method of the present invention.

### DETAILED DESCRIPTION OF A PREFERRED EMBODIMENT

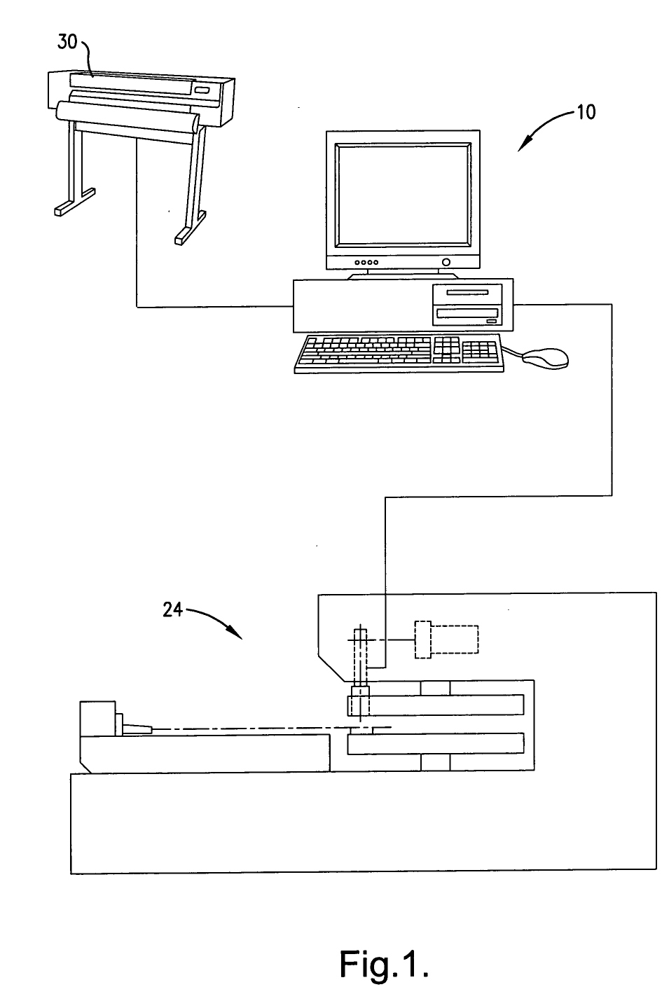

Referring to FIGS. 1&2, the computer program and method in accordance with a preferred embodiment of the present invention are preferably implemented with use of computer equipment 10 to create a support structure 12 for a surface having a dual curve. The computer equipment 10 is preferably capable of not only defining the support structure 12 but also running other computer aided design or drafting (CAD) software, such as AutoCad from Autodesk, Inc. The program and method of the present invention may even be incorporated into the CAD software. For example, some steps of the method may be performed in the CAD software, with other steps being performed outside the CAD software. As such, the program of the present invention may be a supplement added to the CAD software or may simply use a CAD file generated by the CAD software and/or otherwise be completely independent of the CAD software. The computer equipment 10 may comprise one or more individual servers or conventional personal computers, such as those available from Gateway, Hewlett Packard, Dell, IBM, and Compaq.

The computer equipment 10 preferably receives a definition of the surface in the form of a definition file. The computer equipment 10 may receive the definition file over a network or the definition file may be stored on a removable memory media, which is physically transferred to the computer equipment 10. It is important to note that other commonly used methods of transferring computer files may also be used.

The definition file is preferably in AutoCAD format, but may be any other suitable format, such as another design application format, and may be converted into AutoCAD format by the program. The definition file defines the surface, at least in terms of a first curve and a second curve. It should be apparent that the surface is preferably intended to form at least a portion of a building's exterior. Therefore, the definition file may be extracted from a design for the building or created separately thereto.

Where the surface is rectangular, the curves are preferably oriented at approximately ninety degrees with respect to each other. For example, the first curve is preferably taken along a horizontal axis of the surface, while the second curve is preferable taken along a vertical axis of the surface. However, the surface may be virtually any shape and the curves may be oriented at other angles with respect to each other. For example, if the surface is shaped like a parallelogram, then the first curve is preferably taken along one side and the second curve is taken along an adjacent side. In this case, an angle between the curves would substantially match an angle between the sides of the parallelogram. In any case, it should be noted that the curves may or may not be constant. For example, either one or both of the curves may be a simple curve or a compound curve. Furthermore, both curves may be substantially identical, such that the surface forms a portion of a sphere.

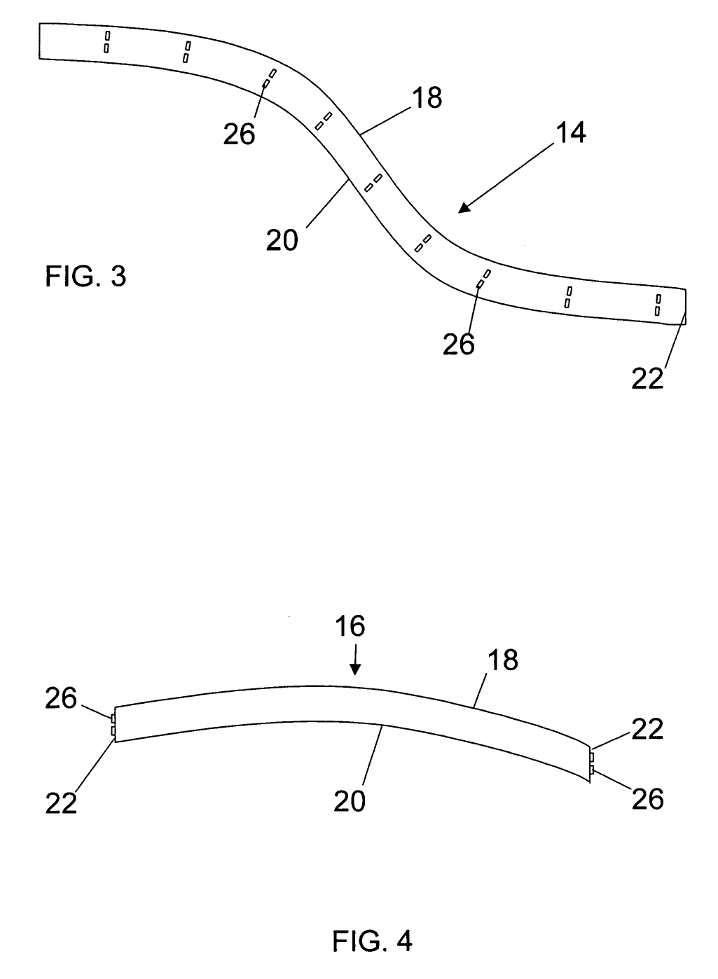

Once the curves have been extracted from the definition file, referring also to FIGS. 3-4, the program defines two or more headers 14 and a plurality of ribs 16 that will be combined to form the support structure 12. The headers 14 and ribs 16 each have a forward edge 18 which preferably contacts the surface, a rear edge 20 opposed to the forward edge 18, and two opposing end edges 22. The headers 14 are preferably defined such that their forward edges 18 match the first curve. The headers 14 are preferably placed on a rear side and adjacent opposing edges of the surface. For example, a first header may be placed along a top edge of the surface, while a second header is placed along a bottom edge of the surface. Alternatively, especially where the surface is rather large, the headers 14 may be spaced along the surface at regular intervals. In either case, the headers 14 are preferably aligned parallel to one another. More specifically, the headers 14 are preferably horizontally aligned one directly above another. However, the headers 14 may be aligned at an angle and/or offset from one another, depending upon the shape of the surface.

The ribs 16 are preferably defined such that their forward edges 18 match the second curve. The ribs 16 are preferably placed normal to and connecting the headers 14. For example, the ribs 16 preferably extend vertically along the surface between the headers 14. The ribs 16 are preferably aligned parallel to one another. More specifically, the ribs 16 are preferably vertically aligned one directly next to another. However, the ribs 16 may be aligned at an angle and/or offset from one another, depending upon the shape of the surface. Furthermore, each rib, or selected ones of the ribs, may be placed at a different angle with respect to neighboring ribs. Such modifications may be necessary to accommodate the curves, manufacturing constraints, or other issues.

It should be noted that the rear edges 20 are preferably parallel to or equidistance from the forward edges 18. However, the rear edges 20 of the headers 14 and/or the ribs 16 may be straight or virtually any other shape. This may be necessary to allow the headers 14 and/or the ribs 16 to be thicker in some places requiring greater strength, while thinner in other places to clear obstacles.

The headers 14 and ribs 16 are preferably cut or punched from sheet metal by a metal working machine 24, as shown in FIG. 1, and are intended to support a metal skin which contacts at least some portion of the forward edges 18, conforms to the curves, and forms the surface, as defined in the definition file. Since the skin is preferably intended to form at least a portion of the building's exterior, the skin must be adequately supported. Therefore, spacing of the headers 14 and ribs 16 can be critical. Factors, such as thickness, length, and strength of the metal from which the headers 14 and ribs 16 are constructed, must be considered by the program, in determining a spacing for the headers 14 and ribs 16. Considering these and any other applicable factors, the program defines the spacing.

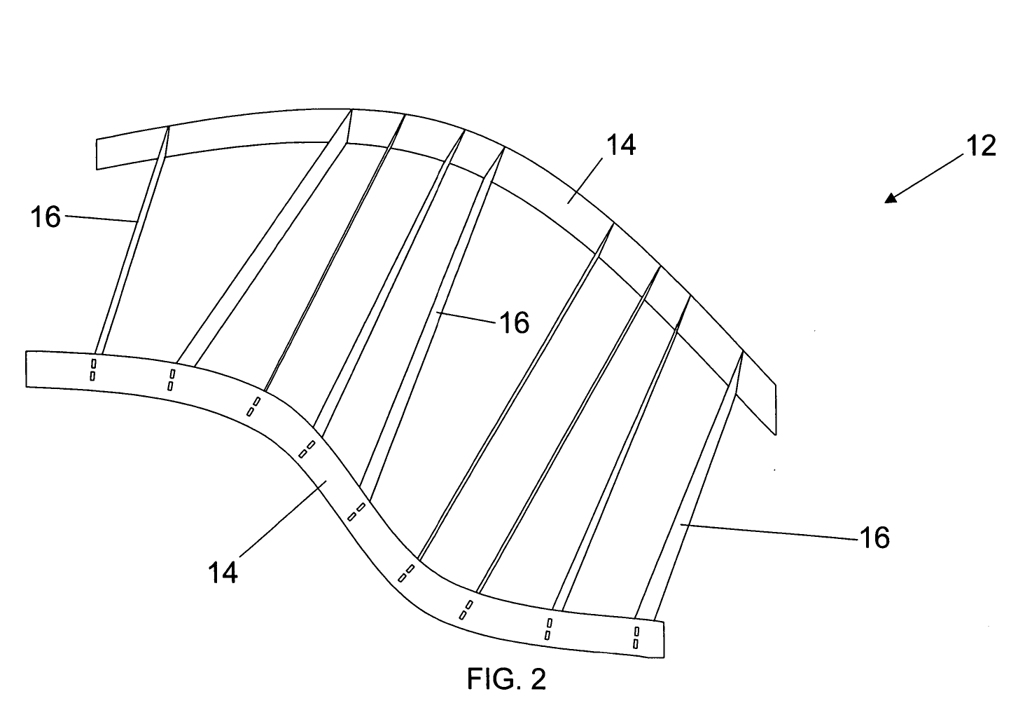

One or more rib angles must also be determined by the program, in order to accommodate the curvature of the surface. The program preferably defines each rib angle to ensure that each rib's 16 forward edge 18 is properly aligned with respect to the headers 14. Additionally, each rib 16 is also preferably normal to the skin, in order to allow the full thickness of the headers 14 and ribs 16 to be used to support the skin. The rib angles may be determined with respect to a reference point or line. It should be noted that the ribs 16 may be aligned substantially normal to the headers 14 or may be angled with respect to three axis. For example, the program may use a constant rib angle, such that each rib 16 would be aligned approximately normal to the headers 14 and substantially parallel to each other. Alternatively, the program may define individual rib angles for each rib 16, as shown in FIG. 2. Furthermore, a user may decide to override any one or more of the rib angles defined by the program and specify selected ones of the rib angles.

The headers 14 are preferably connected to the ribs 16 using a slot and tab attachment system. For example, the headers 14 preferably define a plurality of slots 26 that penetrate the header's 14 sides. Each rib 16 preferably includes at least one tab 28 that extends from each end edge 22 and fits snugly within an appropriate slot 26 in the headers 14. The tabs 28 may be welded or wedged into the slots 26. Thus, the slots 26 and tabs 28 are combined to form attachment points connecting the headers 14 and ribs 16 together.

It should be noted that while one wide tab 28 at each end edge 22 may be sufficient for some applications, the ribs 16 preferably include two or more tabs 28 on each end edge 22. Thus, each header 14 preferably includes a complementary number of slots 26 for each rib 16 that connects thereto. While the tabs 28 simply extend from the end edges 22 of the ribs 16, the slots 26 must be spaced according to the spacing and aligned at the appropriate rib angle. Thus, in defining the headers 14, the program preferably also defines how many slots 26 are needed, as well as each slot's 26 location and orientation.

In the preferred embodiment, defining the headers 14 and the ribs 16 essentially entails generating a unique pattern for each header 14 and each rib 16. The patterns may be displayed within the computer equipment 10, in order to allow the user to visually confirm each header 14 and each rib 16. The patterns may also be printed out on a printer or plotter 30, thereby allowing the user to manipulate the patterns, as well as transfer the patterns to any material he or she chooses. While the patterns are preferably scaled to the exact size of the headers 14 and ribs 16, the patterns may be scaled up or down according the user's wishes. This feature is especially helpful in creating a model or for use in other demonstrative functions.

Once the program receives user approval, the program then generates at least one control file from the patterns which contains machine control code that may be used by the machine 24 to produce the headers 14 and ribs 16. Alternatively, the control file may be generated directly without creating the patterns. In either case, the program generates and makes the control file available to the machine 24. For example, the computer equipment 10 may be directly wired to the machine 24 or may be connected to the machine 24 through a network. Alternatively, the control file may be stored on a removable media, which is physically transferred from the computer equipment 10 to the machine 24. It is important to note that other commonly used methods of transferring computer files may also be used.

It should be noted, that any combination of the above discussed effects may be used to define the headers 14 and ribs 16 that combine into the support structure 12 supporting the surface having dual curves. For example, each header 14 and/or rib 16 may be unique with respect to the other headers 14 and/or ribs 16 and may be substantially straight, have a simple curve, or a compound curve. The shapes of the headers 14 and ribs 16, combined with the spacing, and rib angles, are what allows the support structure 12 accommodate the dual curves of the surface.

While the present invention has been described above, it is understood that substitutions may be made. For example, the definition of the surface may be created within the program itself, thereby not requiring the definition file. Additionally, while all of the headers 14 may be substantially identical, as may the ribs 16, such conformity is not required. For example, as shown in FIG. 2, the headers 14 may have different curvatures, thereby allowing the ribs to be substantially straight. In this case, the surface still embodies more than a single constant curve. Similarly, the headers 14 may be substantially straight and the ribs may have different curvatures. These and other minor modifications are within the scope of the present invention.

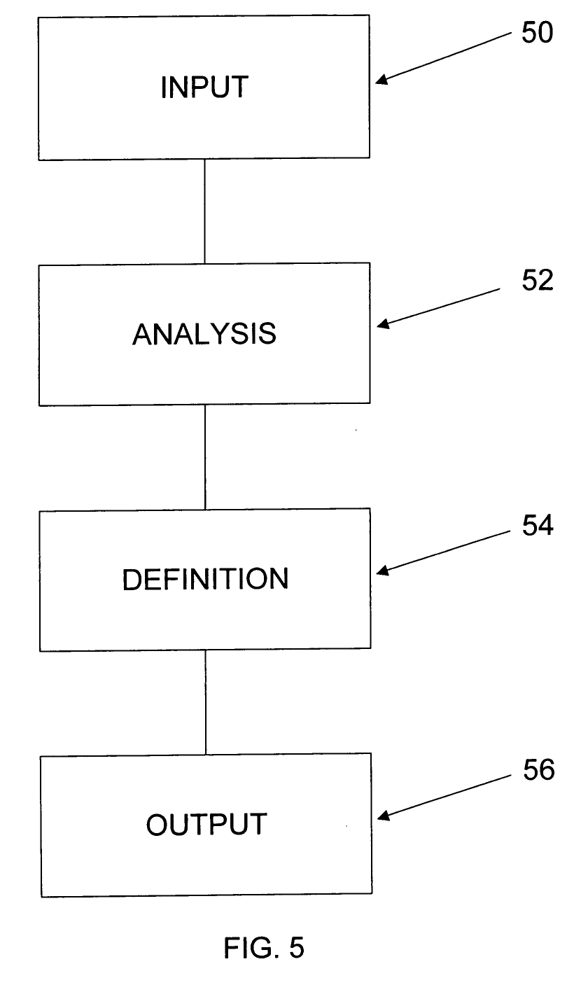

Additionally, while the tasks and processes described herein have been described as being performed by the program, selected ones of those processes may in fact be performed by more than one program or independent processes. For example, referring also to FIG. 5, the program, as described herein, may be comprised of an input process 50, an analysis process 52, a definition process 54, and an output process 56.

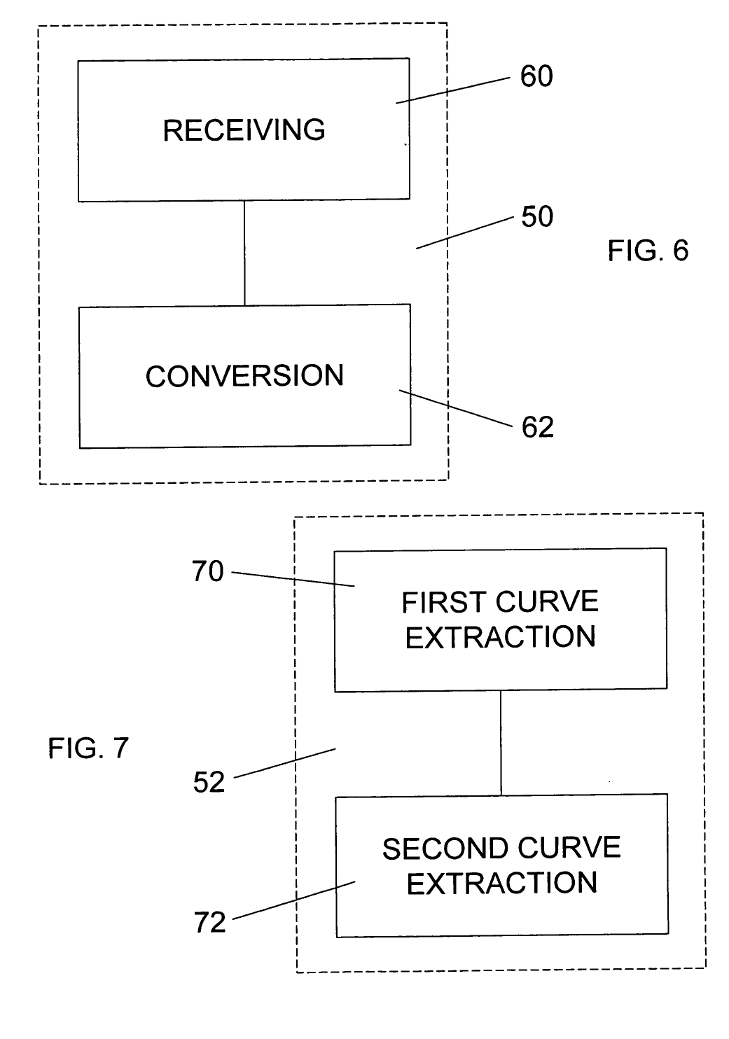

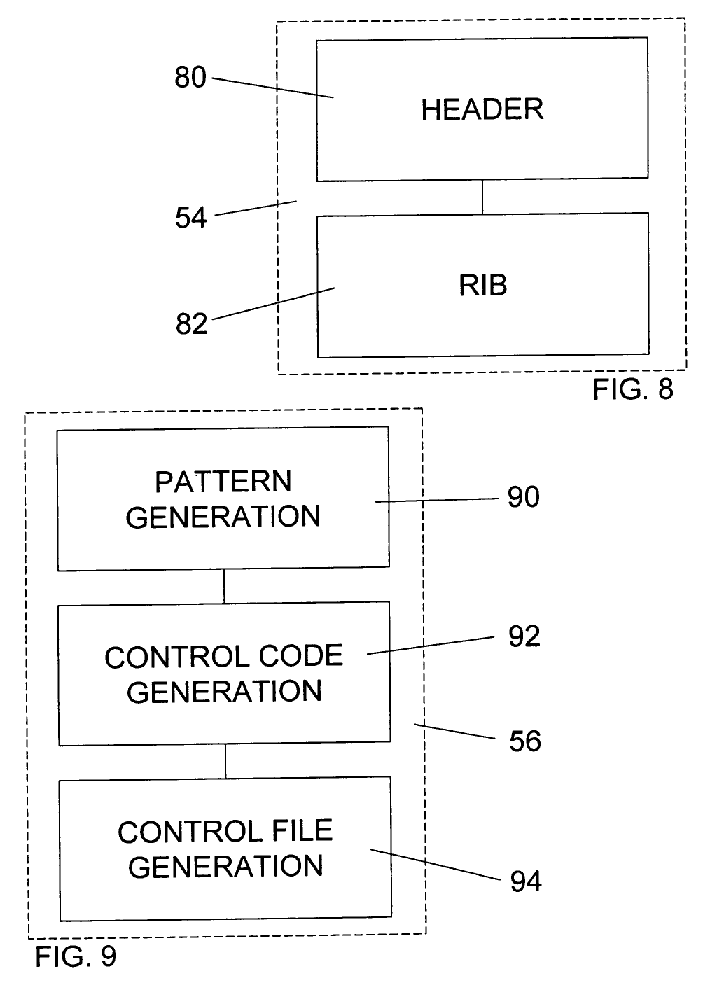

These processes 50-56 may be further distributed into sub-processes. For example, referring also to FIG. 6, the input process 50 may be divided into a receiving sub-process 60 and a conversion sub-process 62. Similarly, referring also to FIG. 7, the analysis process 52 may be divided into a first curve extraction sub-process 70 and a second curve extraction sub-process 72. Referring to FIG. 8, the definition process 54 may be divided into a header sub-process 80 and a rib sub-process 82. Referring also to FIG. 9, the output process 56 may be divided into a pattern generation sub-process 90, a control code generating sub-process 92, and a control file generating sub-process 94.

Additionally, some of the sub-processes may actually be part of a different process. For example, the pattern generation sub-process 90 may actually be part of the definition process 54, rather than the output process 56, as described above. Furthermore, any of the sub-processes may be implemented in hardware or firmware, rather than software. Finally, any of the above sub-processes may be run on computer systems independent from but otherwise similar to the computer equipment 10 described herein.

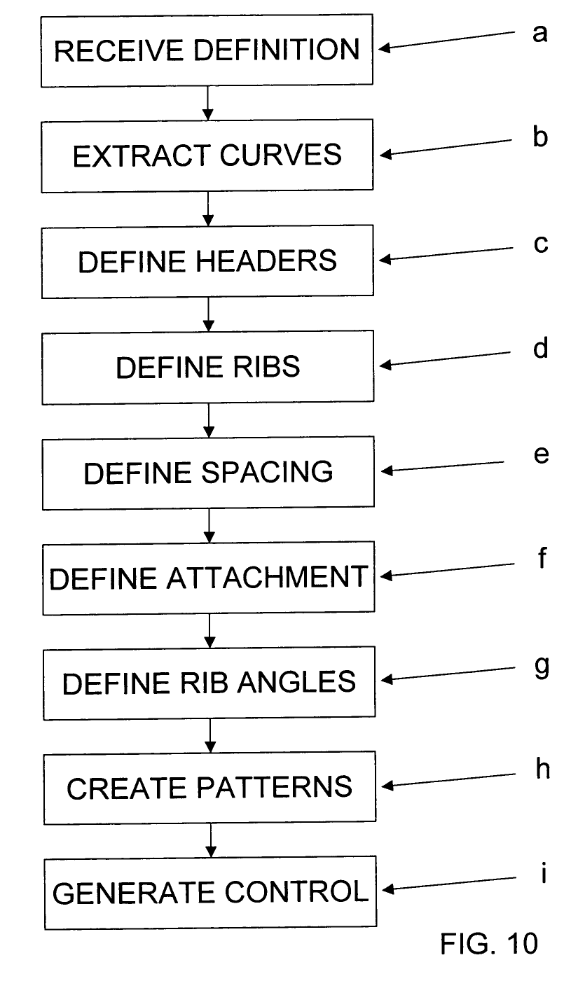

The flow chart of FIG. 10 shows the functionality and operation of a preferred implementation of the present invention in more detail. In this regard, some of the blocks of the flow chart may represent a module segment or portion of code of the program of the present invention which comprises one or more executable instructions for implementing the specified logical function or functions. In some alternative implementations, the functions noted in the various blocks may occur out of the order depicted. For example, two blocks shown in succession may in fact be executed substantially concurrently, or the blocks may sometimes be executed in the reverse order depending upon the functionality involved.

In use, referring also to FIG. 10, the computer equipment 10 receives the definition of the surface, preferably in the form of the definition file, as shown in step a. The program then extracts the first curve and the second curve from the definition file, as shown in step b. The program defines the headers 14 with the forward edge 18 thereof substantially matching the first curve, as shown in step c. The program defines the ribs 16 with the forward edge 18 thereof substantially matching the second curve, as shown in step d. The program defines the spacing for the headers 14 and ribs 16, such that the surface is adequately supported, as shown in step e. The program defines the attachment points for the ribs 16 along the headers 14, as shown in step f. The program defines the rib angles for the attachment points, such that the forward edge 18 of the ribs 16 may be secured flush with and substantially normal to the surface, as shown in step g. The program then defines the patterns for the headers 14 and ribs 16, as shown in step h. Finally, the program generates the control files for use by the machine 24 in producing the headers 14 and ribs 16, as shown in step i.

Having thus described a preferred embodiment of the invention, what is claimed as new and desired to be protected by Letters Patent includes the following:

1. A method of defining a support structure for a dual curved surface, the method comprising the steps of:
receiving a definition of the dual curve surface;
breaking down the definition into a first curve and a second curve;
defining a plurality of headers having an edge that substantially matches the first curve; and
defining a plurality of ribs having an edge that substantially matches the second curve.

2. The method as set forth in claim 1, further including the step of defining spacing for the ribs along the headers, such that the surface is adequately supported.

3. The method as set forth in claim 1, further including the step of defining a plurality of attachment points for the ribs along the headers.

4. The method as set forth in claim 3, further including the step of defining angles for the attachment points such that the edge of the ribs may be secured flush with and substantially normal to the edge of the headers.

5. The method as set forth in claim 1, further including the step of generating at least one control file for use by a machine in producing the headers and ribs.

6. A method of defining a support structure for a dual curved surface, the method comprising the steps of:
receiving a definition of the dual curve surface;
breaking down the definition into a first curve and a second curve that is different from the first curve;
defining a plurality of headers having an edge that substantially matches the first curve;
defining a plurality of ribs having an edge that substantially matches the second curve; and
generating a plurality of control files for use by a machine in producing the headers and ribs.

7. The method as set forth in claim 6, further including the step of defining spacing for the ribs along the headers, such that the surface is adequately supported.

8. The method as set forth in claim 6, further including the step of defining a plurality of attachment points for the ribs along the headers, wherein the attachment point are defined by slots in the headers and tabs extending from the ribs.

9. The method as set forth in claim 8, further including the step of defining angles for the attachment points such that the edge of the ribs may be secured flush with and substantially normal to the edge of the headers.

10. A computer program for generating control files for use by a machine in creating a support structure for a dual curved surface, the program comprising:
a receiving module for receiving a definition of the dual curve surface;
an analysis module for breaking down the definition into a first curve and a second curve; and
a definition module for defining a plurality of headers having an edge that substantially matches the first curve and a plurality of ribs having an edge that substantially matches the second curve.

11. The program as set forth in claim 10, wherein the definition module further defines spacing for the ribs along the headers, such that the surface is adequately supported.

12. The program as set forth in claim 10, wherein the definition module further defines a plurality of attachment points for the ribs along the headers.

13. The program as set forth in claim 12, wherein the definition module further defines angles for the attachment points such that the edge of the ribs may be secured flush with and substantially normal to the edge of the headers.

14. The method as set forth in claim 10, further including a generation module for generating control files for use by a machine in producing the headers and ribs.

15. A computer program for generating control files for use by a machine in creating a support structure for a dual curved surface, the program comprising:
a receiving module for receiving a definition of the dual curve surface;
an analysis module for breaking down the definition into a first curve and a second curve that is different from the first curve;
a definition module for defining a plurality of headers having an edge that substantially matches the first curve and a plurality of ribs having an edge that substantially matches the second curve; and
a generation module for generating control files for use by a machine in producing the headers and ribs.

16. The program as set forth in claim 15, wherein the definition module further defines spacing for the ribs along the headers, such that the surface is adequately supported.

17. The program as set forth in claim 15, wherein the definition module further defines a plurality of attachment points for the ribs along the headers, wherein the attachment point are defined by slots in the headers and tabs extending from the ribs.

18. The program as set forth in claim 17, wherein the definition module further defines angles for the attachment points such that the edge of the ribs may be secured flush with and substantially normal to the edge of the headers.

19. A computer program for generating control files for use by a machine in creating a support structure for a dual curved surface, the program comprising:
a receiving module for receiving a definition of the dual curve surface;
an analysis module for breaking down the definition into a first curve and a second curve that is different from the first curve;
a definition module for—
defining a plurality of headers having an edge that substantially matches the first curve and a plurality of ribs having an edge that substantially matches the second curve,
defining spacing for the ribs along the headers, such that the surface is adequately supported, and
defining a plurality of attachment points for the ribs along the headers, wherein the attachment point are defined by slots in the headers and tabs extending from the ribs; and
a generation module for generating control files for use by a machine in producing the headers and ribs.

20. The program as set forth in claim 19, wherein the definition module further defines angles for the attachment points such that the edge of the ribs may be secured flush with and substantially normal to the edge of the headers.

21. A method of creating a support structure operable to support a surface having a dual curve, the method comprising the steps of:
receiving a definition of the surface;
extracting a first curve from the definition;
extracting a second curve from the surface;
defining at least two headers, with each header having an edge substantially matching the first curve;
defining a plurality of ribs, with each rib having an edge substantially matching the second curve and at least one tab;
analyzing the surface, the headers, and the ribs in order to determine a spacing for the ribs, such that the surface will be adequately supported;
determining a number of ribs needed to support the surface according to the spacing;
determining a location for each of a plurality of slots along the headers for the tabs of the ribs; and
creating machine control code from which a machine may create each of the headers, with the slots, and each of the ribs, with the tabs.
